(19) United States
(12) Patent Application Publication
(10) Pub. No.: US 2014/0280699 A1
(43) Pub. Date: Sep. 18, 2014

(54) METHOD AND APPARATUS FOR ENABLING DISCOVERY AND COMMUNICATIONS BETWEEN UNRELATED BROWSER SESSIONS

(71) Applicant: GENERAL INSTRUMENT CORPORATION, Horsham, PA (US)

(72) Inventors: Shivajit Mohapatra, Arlington Heights, IL (US); Gerald Corrigan, Chicago, IL (US); Manohar Ganesan, Mundelien, IL (US); Mark Tarlton, Barrington, IL (US); Prakairut Tarlton, Barrington, IL (US); Narayanan Venkitaraman, Palatine, IL (US); Jay Williams, Glenview, IL (US)

(73) Assignee: General Instrument Corporation, Horsham, PA (US)

(21) Appl. No.: 13/802,185

(22) Filed: Mar. 13, 2013

(51) Int. Cl. H04L 29/08

(52) U.S. Cl. CPC H04L 67/02
USPC 709/217

(57) ABSTRACT

A method and apparatus for communicating data to a browsing session is disclosed In one embodiment, the method comprises receiving a first information from a first browsing session in a proxy, the first information comprising a request for a webpage having at least one webpage element, transmitting a second information comprising a first wrapper distinct from the requested webpage, establishing a first communications session between the first wrapper and the proxy; and transmitting a third information to the first browser via the first communications session, the third information comprising at least one element based on the requested webpage element for rendering by the first browsing session via the first wrapper.

### BACKGROUND OF THE INVENTION

1. Field of the Invention

The present invention relates generally to systems and methods for browsing information on the world wide web, and in particular, to a method and apparatus that permits communications between unrelated browser sessions.

2. Description of the Related Art

Web browsers are widely used by computer users to access and view information over the Internet. A web browser presents a user with web pages that include textual information, images, and other multimedia information. The web browser also may include a list of links to web pages that the user frequently visits, so that the user may have quick access to these web pages. The web browser also may include navigation controls for the user to go back or go forward among a list of web pages that the user has recently visited.

One limitation of current browser and support designs is that it is difficult to share information between users of unrelated browsing sessions. For example, a first user may be viewing information or data via a first browsing session that they believe might be of interest to a second user on an independent second browsing session. The first user may communicate the information by transmitting the uniform resource locator (URL) of the information and transmitting that to the second user (for example in a chat session or an e-mail). While this technique may be useful to share an entire webpage, it is not generally feasible for sharing elements of a webpage. Furthermore, it cannot communicate arbitrary data, and requires server-side support and if transmission of less than the entire webpage is desired.

Another limitation of current browsers is that while they enable the user to open several webpages at the same time (e.g. by use of multiple tabs) or two different browsers operating on the same machine, they do not allow the user to view the material presented in each tab at the same time within the same browser.

U.S. Pat. No. 7,899,915, hereby incorporated by reference herein, discloses a method and apparatus for browsing using multiple coordinated device sets.

U.S. Patent Publication No. 2009/0037517, hereby incorporated by reference herein, discloses a method and system to share information between two web clients. However, this system designates one of the browsing sessions a master and the other a slave and requires server side support to identify clients. Further, the slave browser only sees changes that are made in the master browser.

U.S. Pat. No. 8,117,258, hereby incorporated by reference herein, discloses distributed computing by a carrier-hosted agent. This discloses an autonomous agent processing data on a client and transmitting the data back to a server, but does not permit communication of arbitrary data across browsing sessions without server side support of user interaction.

Publication WO/2011056110, hereby incorporated by reference herein, discloses communications between multiple web-based applications, but also requires server side support.

Accordingly, there is a need for a system and method that creates a communications channel between one or more browser sessions on multiple systems and allows for communication of data via that communications channel across web-browsing session without server side support or special user interaction. What is also needed is a system and method that permits the user to view and use multiple webpages at a time on the same browser, and to allow the user to define how those different browsing sessions are presented. The present invention satisfies that need.

### SUMMARY OF THE INVENTION

To address the requirements described above, the present invention discloses a method and apparatus for communicating data to a browsing session. In one embodiment, the method comprises receiving a first information from a first browsing session in a proxy, the first information comprising a request for a webpage having at least one webpage element, transmitting a second information comprising a first wrapper distinct from the requested webpage, establishing a first communications session between the first wrapper and the proxy; and transmitting a third information to the first browser via the first communications session, the third information comprising at least one element based on the requested webpage element for rendering by the first browsing session via the first wrapper. In another embodiment, the invention is evidenced by an apparatus comprising a browser session communication system which includes a proxy for receiving a first information from a first browsing session, the first information comprising a request for a webpage having at least one webpage element and for transmitting a second information comprising a first wrapper distinct from the requested webpage; a means for establishing a first communications session between the first wrapper and the proxy, wherein the proxy further transmits a third information to the first browser via the first communications session, the third information comprising at least one element based on the requested webpage element for rendering by the first browsing session via the first wrapper.

### BRIEF DESCRIPTION OF THE DRAWINGS

Referring now to the drawings in which like reference numbers represent corresponding parts throughout:

FIG. 1A is a diagram illustrating an embodiment of a browsing system;

FIG. 1B is a diagram illustrating a webpage rendered in a first browsing session and a second webpage rendered in a second browsing session;

FIG. 2A is a diagram presenting an exemplary process for communicating data to and among independent browsing sessions;

FIG. 2B is a diagram further illustrating the operations performed to transmitting the webpage element from the proxy/BSCS to the first browsing session;

FIG. 3 is a diagram illustrating further detail regarding the operations illustrated in FIGS. 2A and 2B;

FIG. 4 is a diagram illustrating exemplary method steps that can be used to share elements between browsing sessions;

FIG. 5 is a diagram illustrating further detail regarding the operations illustrated in FIG. 4;

FIG. 6 is a diagram illustrating another exemplary method steps that can be used to share elements between browsing sessions;

FIG. 7 is a diagram illustrating further detail regarding the operations illustrated in FIG. 4;

FIG. 8 is a diagram illustrating the “flinging” of a website element from the first browsing session 124A to the second browsing session; and

FIG. 9 is a diagram illustrating an exemplary computer system that could be used to implement elements of the present invention.

### DETAILED DESCRIPTION OF PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

### Overview

The systems and methods discussed below present a unique browsing system that allows the user to overlay different browsing experiences. It enables the user to view and interact with multiple websites at one time in the same browser, without requiring server-side support. To accomplish this, use is made of a “proxy” that operates much like a gateway to provide a unique browsing system that allows the user to overlay different browsing experiences. Using a single browser session, the user can use the below described system to view and interact with multiple websites at the same time. In one embodiment, this can be accomplished by splitting a tab of a browser into two portions, with one website showing on one portion and the other website showing on the other portion. Further, the system and method permits the user to define how they would like to view the multiple websites.

FIG. 1A is a diagram illustrating an embodiment of a browsing system 100. The browsing system comprises a browser session communications (BSCS) system 102 that permits sharing of data between unrelated browser sessions such as a session implemented on browser A 124A and browser B 124B (hereinafter alternatively referred to as browsing session(s) 124 or by referring simply to A and B respectively). These browsing sessions 124 may be running on different computer devices 106A and 106B, or may be running on a single computer device 106A or 106B. Computing devices 106A and 106B (hereinafter alternatively referred to as computing device(s) 106) may be disposed in the same room, household, or building, or may be disposed great distances from one another. Each browsing session 124A and 124B communicates with the BSCS 102 through an associated wrapper 122A and 124B as described further below.

The BSCS 102 comprises a proxy 104, a state manager 108 communicatively coupled to the proxy, a client user interface (UI) manager communicatively coupled to the state manager 108, a data object model (DOM) compositor 112 communicatively coupled to the proxy 104 and the client UI manager 110, a virtual browser 114 communicatively coupled to the DOM compositor 112. The virtual browser has access to widgets 118 and communicates with a world wide web (www) server 116 as further described below.

The BSCS 102 also comprises data storage 120 for storing session information, settings, user information, device information and overlays as shown in items 120A-120E, respectively.

FIG. 1B is a diagram illustrating a webpage 150 rendered in a first browsing session 124A and a second webpage 150′ rendered in a second browsing session 124B. The webpages 150 and 150′(hereinafter alternatively referred to as webpage(s) 150) may comprise one or more elements or I-frames 152A-152D and 152A′-152D′ (hereinafter alternatively referred to as I frames 152) that can be used to display one or more webpage elements within the webpage 150. I frames can be configured by attributes setting the width and height. I frames are defined according to an I frame tag and may be bordered or otherwise embellished and can also be used as a target for another link. The webpage 150 and any of the I frames 152 may include one or more webpage elements such as webpage elements 154A and 154B, respectively, which may be shared by pulling or flinging them from one browsing session 124 to the other as further described below.

The client UI manager 110 implements UI organization options chosen by users for their particular web browsing configuration. These choices may be made in real time. In one embodiment this is made possible by use of HTML root elements having multiple I frames 152. In other embodiments different combinations of containers such as <div>, <iframe>, <canvas> may be used. For example, if a user would like to split a webpage 150 into two portions, with one portion showing a first webpage page and a second portion a second webpage page, the use of a HTML root element with two I frames allows rendering of the first webpage and the second webpages in separate virtual browsers as two different I frames 152. As further described below, the DOM compositor 112 obtains access to the raw webpage elements in the first webpage (for example, element 154A) and the second webpage (for example, element 154B), and places the those accessed elements in the appropriate I frames 152. The client UI manager 110 manages how the user will see the two webpages (e.g. side by side, above and below, or merged together) based on client instructions modifying overlay webpages as further discussed below.

The virtual browser 114 communicates with the server 116 to retrieve webpages 150 requested by the browsing sessions 124. The virtual browser 114 also renders and processes those webpages 150 to obtain the webpage elements 154 of those webpages 150. Then, the virtual browser 114 strips any webpage 150 event handlers from the webpages 150 and wraps event handlers pertinent to the BSCS 100 presentation of the webpage elements 154 to capture the retrieved elements 154.

The DOM compositor 112 adds overlay UI elements on the elements 154 retrieved by the virtual browser 114. The DOM compositor 112 also allows overlays to be added to webpage elements 154 retrieved by the virtual browser 114 including webpage picture elements. This permits user interface menus and the like to be added to the retrieved webpage elements 154 as further described below. When the DOM compositor 112 has complete the composition, the DOM provided to the proxy 104.

The proxy 104 is presented to each of the browsing session as an external world wide web (www) server 116, and intercepts information such as webpage requests and events transmitted from the browsing sessions 124 to the www server 116 during browsing sessions 124. Further description of proxy 104 operations is discussed below. In one embodiment, the proxy 104 is an HTTP proxy.

The widgets 118 permit the BSCS 102 to present its own HTML that allows elements from requested webpages to be presented in alternate ways or to present additional elements not on either of the requested webpages. Widgets 118 may include a clock, a timer, or a weather application, for example. As indicated by the location of the widget block 118 on the diagram, the code for the widgets 118 may be internal or external to the BSCS 102.

Using the foregoing, the user may present, according to a UI of the user's choice, a webpage that includes elements from a number of other webpages.

FIG. 2A is a diagram presenting an exemplary process for communicating data to and among independent browsing sessions 124. First information comprising request for a webpage 150 specified by a uniform resource locator (URL) address is transmitted from the first browsing session 124A, as shown in bock 204. The requested webpage 150 comprises one or more resources, which may include a webpage element 154 such as a photo, text, or other media. Although that request would typically be sent from the first browsing session 124A to the www server 116, the BSCS 102 (which is interposed in the communication path between the www server 116 and the browser 124A) intercepts and acts upon this request. Specifically, the request is received in the proxy 104, as shown in block 206. In one embodiment, this request is transmitted via an hypertext transfer protocol (HTTP) or analogous.

The request is received by the proxy 104, and the proxy 104 generates a second message that comprises a wrapper 205A. The wrapper 205A is then transmitted to the first browsing session 124A as shown in block 210.

The wrapper 205A includes code such as JavaScript that, when executed by the processor 106A, establishes a full duplex communication channel distinct from the communications channel used to transmit the initial HTTP request and receive the wrapper 205A itself. The full duplex communication channel can be established over a single transmission control protocol (TCP) connection, and can comprise, for example, a websocket connection, as illustrated in FIG. 2A.

Using the established communication session 202, the proxy 104 then transmits third information to the first browsing session 124A via the wrapper 205A. In one embodiment, the third information comprises at least one webpage element 154 of the requested webpage 150 for rendering. The first browsing session 124A receives the third information, and renders the webpage element, as shown in block 220.

FIG. 2B is a diagram further illustrating the operations performed to transmitting the webpage element from the proxy 104/BSCS 102 to the first browsing session 124A. An overlay is retrieved, as shown in block 224. The overlay comprises one or more overlay elements and defines the presentation of the webpage elements 154 and other data in the webpage 150 rendered in the first browsing session 124A. The overlay may be retrieved from storage 120E or can be retrieved from a remote source, for example, a www server 116. Typically, the overlay is retrieved by the DOM compositor 112 via the virtual browser 114.

Using the overlay, the DOM compositor 112 generates DOM information including a wrapper 122A root element from the retrieved overlay, as shown in block 226. Next, the requested webpage 150 having the webpage elements 154 is retrieved, as shown in block 228. Second DOM information is generated from the requested webpage 150, as shown in block 230. The first and second DOM information, the overlay, and the requested webpage element 154 is then transmitted to the first browsing session 124A using the first communication session 202 via the wrapper 122A. The first browsing session 124A receives the first and second DOM information and requested webpage element 154 and renders the webpage element 154 at least in part according to the first DOM information and the second DOM information, as shown in block 234.

Although FIG. 2B discloses the first and second DOM, overlay, and requested webpage element could be transmitted at the same time or in the same message, the first DOM information and overlay could be transmitted to the first browsing session 124A before or while the requested webpage is being retrieved, with the second DOM information and the requested webpage element subsequently transmitted. This embodiment is further described below.

FIG. 3 is a diagram illustrating further detail regarding the operations illustrated in FIGS. 2A and 2B. First, a first browser session 124A operating on computer 106A (also alternatively referred to a first client or “client 1” hereinafter) transmits a GET reqURL message to the proxy 104, thus makes a request for a webpage at the requested URL, reqURL. That message is received by proxy 104.

The proxy 104 then authenticates the first browsing session 124A, and determines whether a new communication session 202 needs to be set up between the proxy 104 and the client 124A, or whether a communication session 202 already exists for the requested webpage 150. This can be accomplished via a cookie stored by client 124A and retrieved by the proxy 104 or operated on by the browser 124A. The proxy 104 may also engage client 124A in an authentication process by transmitting authentication information from the proxy 104 to client 124A or by transmitting a message requesting a cookie stored in client 124A.

If a new communications session is required, the client 124A again transmits a GET reqURL message having the URL of the requested webpage 150, along with the client's authentication credentials. The proxy 104 assigns a userID to client 124A, and transmits the userID and the reqURL to the state manager 108 to begin a new communications session. The state manager 108 creates an entry for the new session, generates a new session cookie and sessionID, as well as a wrapper, and transmits them to the client 124A via the proxy 104.

Typically, the same wrapper 122 is transmitted to all clients 124A and 124B. The wrapper 122A includes code such as Javascript to create a two-way backchannel link to the HTTP session using an HTTP independent communication connection such as a websocket, long polling or CEA201 NotifSocket session connection. As is known in the art, websockets provide full-duplex communication channels over a single transmission control protocol (TCP) connection. Although designed to be implemented in web browsers 124 and web servers 116, websockets can also be used by other client types. As further described below, the wrapper may include a list of other browsing sessions communicating with the BSCS 102 and a second script for establishing a context of the first browsing session 124A to the client The websocket connection protocol allows greater interaction between the browser 124 and the website, including live content and games, and is used to create a backchannel to the proxy 104 of the BSCS 102. NotifSocket is a standard component of a CE-HTML compliant browser [CE-HTML]. It is offered by the browser as a java-scriptable object. Through JavaScripting a persistent TCP/IP connection between the client and a server can be set-up. This allows for an arbitrary asynchronous transfer of information between client and server.

Long polling is a variation of the traditional polling technique and allows emulation of an information push from a server to a client. With long polling, the client requests information from the server in a similar way to a normal poll. However, if the server does not have any information available for the client, instead of sending an empty response, the server holds the request and waits for some information to be available. Once the information becomes available (or after a suitable timeout), a complete response is sent to the client.

The fact that backchannel communication has been established between the client 124A and the proxy 104 is communicated to the state manager 108. The wrapper 122A has code such as JavaScript for implementing the websocket, for DOM control, for event capture, for obtaining device (e.g. computer 106A implementing the client 124A) info, as well as HTML with a rootlD.

Next, the proxy 104 transmits a message to the client 124A to query the client 124A regarding the configuration of the relevant processing, memory, and software. This device information is communicated back to the state manager 108 via the proxy 104, and stored by the state manager 108. At this point, the communications session between the BSCS 102 and the client 124A is now established, and the state manager 108 has information about the client 124A configuration. However, at this point, the requested webpage at reqURL has still not been provided to the client 124A.

Next, the state manager 108 sends a session identifier (sessionID), user identifier (user ID), device information (Dev) and the URL of the requested website (reqURL) to the client UI manager 110. The client UI manager 110 communicates with the document object model (DOM) compositor 112 and informs the DOM compositor 112 that a new session with the session identifier has begun, and queues the DOM compositor 112 to begin the composition of a DOM according to a rootlD and an overlay. In one embodiment, the overlay is retrieved via a URL (overlayURL) and is retrieved from an external server.

A DOM is a cross platform and language-independent conversion for representing and interacting with objects in markup languages such as HTML. The DOM is used to render documents in the markup language. The nodes of each document are organized into a tree structure called a DOM tree, with the topmost node named the “document object.” When a browser 124 downloads and renders an HTML page, the HTML is downloaded into local memory and automatically parsed to identify and format elements for presentation within the browser 124A. The DOM is also used by JavaScript to transmit the state of the browser 124A in HTML pages.

The DOM compositor 112 transmits a message to the virtual browser 114 to get the overlay specified by the client UI manager 110 at the overlayURL address. The virtual browser 114 accesses an overlay server 116 and retrieves the HTML for the overlay, and passes this information along to the DOM compositor 112. The DOM compositor 112 generates an overlay Tab ID to uniquely identify the overlay HTML page, along with identifiers and types of the elements of the overlay page (elementID and elementType, respectively), and provides this data to the client UI manager 110. This information provides an identifier for each of the elements in the overlay HTML page, and events that may be invoked by those elements. For example, one of the elements may include a video and the events invoked by that element may be user commands to begin or pause playing of that video. The client UI manager 110 then subscribes to the elementIDs and the events implicated by the overlay HTML page. This allows the DOM compositor 112 to update events when the final webpage is transmitted to client 124A. That is, when an event happens in the page rendered by the client 124A, the client UI manager 110 will be notified of that event via the subscribed elements and events with the DOM compositor 112.

The DOM compositor 112 then transmits a message having the session ID, an overlay HTML page ID, and the DOM information (sessionID, overlayTabID, and DOM info) to the proxy 104. The proxy 104 then transmits a message comprising the overlay HTML page ID and the DOM information (TabID and DOM info) to the client 124A. At this point, the client 124A has still not received any of the information or elements specified in the initial GET reqURL message.

The client UI manager 110 transmits a message having the session ID, the overlay ID and the parent ID the parentlD corresponds to the ID of an element in the DOM under which the new elements need to be placed to the DOM compositor 112, and the DOM compositor 112 obtains the requested webpage HTML and other information via the virtual browser 114. The DOM compositor 112 transmits the TabID for the requested webpage (reqTabID) and the element IDs and element types to the client UI manager 110, again so that events can be updated and managed as required.

Finally, the DOM compositor 112 transmits the session ID, the TabID of the requested webpage and further DOM info related to the requested webpage to the proxy 104. The proxy 104 forwards the TabID and DOM info for the requested webpage to the client 124A.

As a result, the client UI manager 110 uses an overlay HTML page to render the style and organization of requested webpages as they are added. The client UI manager 110 may have access to a cadre of predesigned overlay HTML pages, and select the best overlay HTML page according to input from the user of the client 124A. The overlay HTML pages may be obtained from an internal or external overlay server 116 as illustrated above, or be stored local to the client UI manger 110.

After_the retrieved overlay HTML page and its elements are retrieved and provided to the client 124A, they are rendered to create an overlay structure in which the other webpage elements from other webpages may be rendered. In one embodiment that overlay structure essentially comprises a blank document with a root element under which additional HTML or elements can be added, for example, as different I frames. The client UI manager 110 thereafter retrieves the webpage that the client 124A actually requested, and renders the elements of that webpage using the overlay by inserting it as one of the I frames. Accordingly, retrieved webpages can be stacked side-by-side or one on top of the other, and new webpages can be inserted as children of the overlay (basic) page.

Since the elements of each webpage are identified and events on those elements are tracked, by virtue of the client UI manager 110 subscribing to element IDs and related events from DOM compositor 112, the presentation of such elements can be customized and different responses to element events can be defined. For example, the client UI manager 110 may intercept a particular event occurring on an element and substitute a different event computed from or based on the intercepted event for transmission to the source of the webpage element. Or, alternatively, the client UI manager 110 may intercept the event and provide a response to the event different than that which would have been provided by the source of the webpage element. The foregoing illustrates an embodiment wherein the overlay and the elements from the requested webpage are transmitted in separate messages. However, in other embodiments, the overlay and requested webpage elements can be sent in the same message or at the same time.

Information “pushing” describes a style of Internet-based communication wherein the request for a given transaction is initiated by the publisher. It is contrasted with “pulling,” wherein the request for the transmission of information is initiated by the receiver or client.

FIG. 4 is a diagram illustrating exemplary method steps that can be used to share elements between browsing sessions. In this embodiment, one or more elements 154 of the first webpage 150 of the first browsing session 124A are “pulled” to the second browsing session 124B. First, as shown in block 402, a second data communications channel is established between the second browsing session 124B and the proxy 104/BSCS 102. This is accomplished by performing steps analogous to those illustrated in blocks 202 of FIG. 2A, but with respect to the second browsing session 124B instead of the first browsing session 124A. Communications from the proxy to the second browsing session 124B are thereafter performed via a second wrapper 122B using the second communications session, typically using websockets. These steps may be initiated in response to an invitation transmitted from the first browsing session 124A to the second browsing session 124B.

A message is transmitted from the second wrapper page 122B of the second client or browsing session 124B to the proxy 104 of the BSCS 102 using the second communication session. The message comprises an identifier of the second browsing session 124B and an identifier of the webpage element 154 requested by the second browsing session. This is illustrated in block 404. The proxy 104 receives the message and transmits the requested webpage element, as shown in blocks 406 and 408. In blocks 410 and 412, the second browsing session 124B receives the webpage element and renders the webpage element, as shown in blocks 410 and 412.

FIG. 5 is a diagram illustrating further detail regarding the operations illustrated in FIG. 4. First, the first browsing session or second client 124B establishes a second communications session as described above with respect to FIG. 3. In the situation posited in FIG. 3, information about the first computer of the first client 124A (Dev info) was transmitted from the proxy 104 to the client 124A to retrieve device information. In the embodiment shown in FIG. 5, it is presumed that information regarding the computer implementing the second client 124B has already been transmitted from the second client 124B to the proxy 104 and state manager 108 and thereafter stored. Hence, the state manager 108 can retrieve information regarding the computer implementing the second client 124B by looking up the device information (Dev info) using an identifier or the second client 124 or a cookie transmitted from the second client 124B to the state manager 108 via the proxy 104. This is illustrated in block 502. The state manager 108 then transmits a message regarding the new session to the client UI manager 110. The message includes a session ID and user ID for the second session. The device information regarding the computer implementing the second client 124B may also be transmitted to the client UI manager 110. If the second client 124B initiated the communications session with a requested webpage having a URL, that information is also provided from the state manager 108 to the client UI manager 110.

Next, the overlay for the second browsing session 124B is set up using the analogous operations presented in FIG. 3. This includes the sharing of element IDs and element types for the overlay, and the client UI manager 110 and DOM compositor 112 subscribing to the specified element IDs and event types.

Pertinent overlay information (including the overlayTabID and DOM information) is gathered and transmitted to the proxy 104, along with the session ID of the new session established with the second client 124B. The overlayTabID in this case is an ID corresponding to the tab in the second browsing session or client 124B which may, but need not be identical to the overlayTabID of the first browsing session 124A.

The proxy 104 transmits the overlayTabID and the DOM information to the second client 124B via the second communication session. Hence, the basic process used to establish a communications session is the same for the second browsing session 124B as it was for the first browsing session 124A. When the browser 124B is activated in the second client, it joins the proxy 104 by fetching a wrapper addressed at a url (for example, http://proxy). This brings the wrapper 122B to the second client 124B, which is used to create the second communications session via a websocket session and prepare the second client for the pushing and/or pulling of webpages and webpage elements.

In one embodiment, the second client is presented with a UI listing the elements that it can pull from first browsing session. When the user selects an element from that list, it triggers a “pull event.” When the second client 124B receives a command to “pull” a webpage element 154 from the first browsing session 124A into the webpage or overlay of the second browsing session 124B, an associated “pull” event occurs in the second browsing session 124B. The second browsing session 124B transmits information related to the event (including the element ID and event type for the “pull” event) to the DOM compositor 112 via the second communication session with the proxy 104. As the client UI manager 110 has subscribed to the event, the DOM compositor 112 transmits the eventlD, event type, and session ID associated with the event to the client UI manager 110. The client UI manager 110 transmits a pull command having the identifier (fromSession ID) of the browsing session displaying the webpage of the element being pulled to the second browsing session (in the illustrated example, the first browsing session 124A). The state manager 106 looks up the pending browsing and or communication sessions, as shown in block 504, which may include communication/browsing sessions in addition to the first communication session between the proxy 104 and the first browsing session 124A and the second communication session between the proxy 104 and the second browsing session 124B. The user interface implemented in the second browsing session 124B enables the user to choose which webpage elements they would like to pull from the first browsing session 124A.

The state manager 108 then determines if the second browsing session 124B is authorized to pull the selected webpage element from the first browsing session 124A to the second browsing session 124B. This authorization may be based, for example on first browsing session 124A preferences (e.g. whether sharing webpage elements 154 with others is authorized, which may be on an webpage element-by-webpage element basis and/or a browsing session 124 by-browsing session 124 basis), second browsing session 124B preferences (e.g. whether the second browsing session 124 is permitted to pull particular webpage element 154 types), or state manager 106 preferences (e.g. whether copyright or other laws permit the pulling of the selected webpage element 154 from the first browsing session 124A to the second browsing session 124B).

If the state manager 108 authorizes pulling the webpage element 154 from first browsing session 124A (identified by the fromSessionID) to the second browsing session 124B (identified by the toSessionID), the state manager 108 indicates as such by transmitting an OK message to the client UI manager 110. The client UI manager 110 then sends a move command to the DOM compositor 112 which transmits the webpage element to the second browsing session 124B for rendering. A message is also transmitted to the first browsing session 124A to commit any changes so that the first browsing session 124A is synchronized with the BSCS 102. Logic in the client (e.g. the wrapper 122A) may communicate with the virtual browser 114 to save the states so that the states may be provided to the second browsing session 124B as needed. There may be states in the first browsing session 124A that may not be transmitted, for example, data typed into a form.

FIG. 6 is a diagram illustrating another exemplary method steps that can be used to share elements between browsing sessions. In this embodiment, one or more elements 154 of the first webpage 150 of the first browsing session 124A are “pushed” or “flung” to the second browsing session 124B. First, as shown in block 402, a second data communications channel is established between the second browsing session 124B and the proxy 104/BSCS 102. This is accomplished by performing steps analogous to those illustrated in blocks 202 of FIG. 2A, but with respect to the second browsing session 124B instead of the first browsing session 124A. Communications from the proxy to the second browsing session 124B are thereafter performed via a second wrapper 122B using the second communications session, typically using websockets. These steps may be initiated in response to an invitation transmitted from the first browsing session 124A to the second browsing session 124B.

Next, the first browsing session 124A transmits a message to the proxy 104 via the wrapper 122A and the first communications session implemented by the websocket 122A. The message includes the ID of the second browsing session 124B (or the browsing session 124 to which the webpage element 154 is to be flung) and an identifier of the webpage element 154 to be flung, along with any additional information required to render the element remotely. For example, to fling an <img> element, the message may optionally include the image “src” property. BSCS 102 receives the message, obtains the requested element, and transmits that webpage element to the second browsing session 124B using the second communication session and the second wrapper 122B implemented in the second browsing session 124B, as shown in blocks 606 and 608. Thereafter, the second browsing session 124A renders the flung webpage element 154, as shown in block 612.

FIG. 7 is a diagram illustrating further detail regarding the operations illustrated in FIG. 4. First, the first communication session is set up between the first client 124A and the client UI manager 110 via the proxy 104 and a second browsing session is set up between the second browsing session or second client 124B or second client 124B establishes a second communications session as described above with respect to FIG. 3. FIG. 8 is a diagram illustrating the “flinging” of a website element 154″ from the first browsing session 124A to the second browsing session 124B. FIG. 7 is discussed with reference to FIG. 8 where applicable.

First, the user associated with browsing session 124A selects an webpage element 154″ to be flung. This can be implemented by appropriate code in the first wrapper 122A. The code may also implement an interface 802 presented in association with the webpage element 154″ that can be selected by the user to determine where the webpage element 154″ will be flung. In the illustrated embodiment, the code imports information from the proxy 104 identifying other sessions to which the webpage element 154″ may be flung. This information can be presented in the interface 802 to allow the user to fling the webpage element 154″ to a particular browser session 124 or to broadcast or multicast the webpage element 154″ to browser sessions who have authorized the receipt of such broadcasts or multicasts.

After the user selects the webpage element 154 to be flung to from the first browsing session 124A to the second browsing session 124B, the first browsing session transmits an event comprising the element identifier (elementID) of the webpage element 154 to be flung and the event type (evenType), which, in this case, is a “fling” event. This message is sent via the first communication session between the first browsing session 124A and the proxy 104. The proxy 104 receives the message and forwards the received information and an identifier for the first communication session (sessionID) to the DOM compositor 112. The DOM compositor 112 then transmits the first communication session identifier, element ID, and event type, along with the overlayTabID to the client UI manager 110. The client UI manager 110 generates a fling command having the identifier of the first communications session where the webpage element 154 is flung from (fromSessionID), the identifier of the second communications session where the webpage element 154 is flung to (toSessionID), and an identifier of the webpage element 154 to be flung.

The state manager 108 looks up the sessions associated with the fromSessionID and toSessionID identifiers, determines whether the flinging the webpage element 154 from the first browsing session 124A to the second browsing session 124B is authorized, as shown in block 702. Authorization may be performed for example using a configured data base providing information on devices that can pull from one another. There may also be restrictions based on url of the web page or tags in the page. Authorization is based on a user/client/iframe basis. If the fling of the webpage element 154 is authorized, the state manager 108 transmits an OK message to the client UI manager 110. The client UI manager 110 then sends a message requesting that the DOM compositor 112 update the second communications session. This request includes the session ID associated with the second browsing session 124B (toSession ID), the overlayTabID and logic for execution by the second browsing session 124B that provides the user of the second browsing session 124B with the choice to accept the flung webpage element or not. This could comprise of HTML/JS/CSS that is added to the overlay page. The DOM compositor 112 forwards this information to the virtual browser 114, which retrieves updated information regarding the requested webpage element and commands the DOM compositor 112 to update the DOM using this information.

The Client UI manager 110 subscribes to the element IDs and event types associated with the event, and the DOM compositor 112 transmits an update comprising the toSessionID, the updated overlayTabID, and updated DOM information to the proxy 104. Using the toSessionID, the proxy 104 sends the overlay TabID and DOM information to the second browsing session 124B. This DOM information may implement a control by which the user of the second browsing session 124B is presented with an interface control 804 which provides the user with the choice of accepting or rejecting the flung webpage element 154″. If the user rejects the flung webpage element 154″, the first browsing session 124A may be informed of this refusal via the BSCS 102.

If the user accepts the flung webpage element 154″, an event associated with the interface control 804 is noted and the element ID and event type for the event is transmitted from the second browsing session 124B to the DOM compositor 112 via the proxy 104. The DOM compositor 112 informs the client UI manager 110 of the received event, and the client UI manager 110 requests that the DOM compositor 112 perform an update for the overlayTabID and to add the flinged item to the DOM information. The DOM compositor 112 then sends an update to the proxy 104 comprising the session ID identifying the second browsing session 124B, and the updated overlayTabID and DOM information along with the flung webpage element 154″.

Finally, the first browsing session 124A is updated as well. For this, the client UI manager 110 requests that the DOM compositor 112 perform an update for the overlayTabID and associated with the second browsing session 124B (fromSessionID) to add any information required to manage the flung webpage element 154″. The DOM compositor 112 updates this information and transmits the update of the overlayTabID and DOM information to the first browsing session 124A via the proxy 104.

### Hardware Environment

FIG. 9 is a diagram illustrating an exemplary computer system 900 that could be used to implement elements of the present invention, including the first browsing session 924A, the second browsing session 924B, the BSCS 902 elements, and the web server 916. A computer 902 comprises a general purpose hardware processor 904A and/or a special purpose hardware processor 904B (hereinafter alternatively collectively referred to as processor 904) and a memory 906, such as random access memory (RAM). The computer 902 may be coupled to other devices, including input/output (I/O) devices such as a keyboard 914, a mouse device 916 and a printer 928.

In one embodiment, the computer 902 operates by the general purpose processor 904A performing instructions defined by the computer program 910 under control of an operating system 908. The computer program 910 and/or the operating system 908 may be stored in the memory 906 and may interface with the user and/or other devices to accept input and commands and, based on such input and commands and the instructions defined by the computer program 910 and operating system 908 to provide output and results.

Output/results may be presented on the display 922 or provided to another device for presentation or further processing or action. In one embodiment, the display 922 comprises a liquid crystal display (LCD) having a plurality of separately addressable pixels formed by liquid crystals. Each pixel of the display 922 changes to an opaque or translucent state to form a part of the image on the display in response to the data or information generated by the processor 904 from the application of the instructions of the computer program 910 and/or operating system 908 to the input and commands. Other display 922 types also include picture elements that change state in order to create the image presented on the display 922. The image may be provided through a graphical user interface (GUI) module 918A. Although the GUI module 918A is depicted as a separate module, the instructions performing the GUI functions can be resident or distributed in the operating system 908, the computer program 910, or implemented with special purpose memory and processors.

Some or all of the operations performed by the computer 902 according to the computer program 910 instructions may be implemented in a special purpose processor 904B. In this embodiment, some or all of the computer program 910 instructions may be implemented via firmware instructions stored in a read only memory (ROM), a programmable read only memory (PROM) or flash memory within the special purpose processor 904B or in memory 906. The special purpose processor 904B may also be hardwired through circuit design to perform some or all of the operations to implement the present invention. Further, the special purpose processor 904B may be a hybrid processor, which includes dedicated circuitry for performing a subset of functions, and other circuits for performing more general functions such as responding to computer program instructions. In one embodiment, the special purpose processor is an application specific integrated circuit (ASIC).

The computer 902 may also implement a compiler 912 which allows an application program 910 written in a programming language such as COBOL, C++, FORTRAN, or other language to be translated into processor 904 readable code. After completion, the application or computer program 910 accesses and manipulates data accepted from I/O devices and stored in the memory 906 of the computer 902 using the relationships and logic that was generated using the compiler 912.

The computer 902 also optionally comprises an external communication device such as a modem, satellite link, Ethernet card, or other device for accepting input from and providing output to other computers.

In one embodiment, instructions implementing the operating system 908, the computer program 910, and/or the compiler 912 are tangibly embodied in a computer-readable medium, e.g., data storage device 920, which could include one or more fixed or removable data storage devices, such as a zip drive, floppy disc drive 924, hard drive, CD-ROM drive, tape drive, or a flash drive. Further, the operating system 908 and the computer program 910 are comprised of computer program instructions which, when accessed, read and executed by the computer 902, causes the computer 902 to perform the steps necessary to implement and/or use the present invention or to load the program of instructions into a memory, thus creating a special purpose data structure causing the computer to operate as a specially programmed computer executing the method steps described herein. Computer program 910 and/or operating instructions may also be tangibly embodied in memory 906 and/or data communications devices 930, thereby making a computer program product or article of manufacture according to the invention. As such, the terms “article of manufacture,” “program storage device” and “computer program product” or “computer readable storage device” as used herein are intended to encompass a computer program accessible from any computer readable device or media.

Of course, those skilled in the art will recognize that any combination of the above components, or any number of different components, peripherals, and other devices, may be used with the computer 902.

Although the term “computer” is referred to herein, it is understood that the computer may include portable devices such as cellphones, portable MP3 players, video game consoles, notebook computers, pocket computers, or any other device with suitable processing, communication, and input/output capability.

### CONCLUSION

This concludes the description of the preferred embodiments of the present invention. The foregoing description of the preferred embodiment of the invention has been presented for the purposes of illustration and description. It is not intended to be exhaustive or to limit the invention to the precise form disclosed. Many modifications and variations are possible in light of the above teaching.

It is intended that the scope of the invention be limited not by this detailed description, but rather by the claims appended hereto. The above specification, examples and data provide a complete description of the manufacture and use of the apparatus and method of the invention. Since many embodiments of the invention can be made without departing from the scope of the invention, the invention resides in the claims hereinafter appended.

What is claimed is:

1. A method of communicating data to a first browsing session, comprising:
receiving a first information from a first browsing session in a proxy, the first information comprising a request for a webpage having at least one webpage element;
transmitting a second information comprising a first wrapper distinct from the requested webpage;
establishing a first communications session between the first wrapper and the proxy; and
transmitting a third information to the first browser via the first communications session, the third information comprising at least one element based on the requested webpage element for rendering by the first browsing session via the first wrapper.

2. The method of claim 1, wherein:
the first wrapper comprises a script and a wrapper root element;
establishing first communications session comprises executing the script; and
the first browsing session renders the requested webpage element in the wrapper root element.

3. The method of claim 1, wherein:
the first information and the second information are HTTP compliant; and
the first communications session is HTTP independent.

4. The method of claim 1, wherein the first wrapper includes a list having at least one other browsing session communicating with the proxy via a second communications session.

5. The method of claim 1, wherein the first wrapper includes a second script for establishing a context of the first browsing session to the proxy.

6. The method of claim 2, wherein transmitting the third information to the first browser via the first communications session comprises the steps of:
retrieving an overlay having overlay elements, the overlay defining a presentation of data in the first browsing session;
generating first data object model information including the wrapper root element from the retrieved overlay; and
transmitting the first data object model information to first browsing session via the first communications session;
wherein the requested webpage element is rendered by the first browsing session via the first wrapper at least in part according to the first data object model information.

7. The method of claim 6, further comprising:
retrieving the requested webpage having the requested webpage element;
generating second data object model information using the retrieved webpage element; and
transmitting the generated second data object model information and the requested webpage element to the first browsing session via the first communications session;
wherein the requested webpage element are rendered by the first browser communications session via the first wrapper according to the first data object model information and the second data object model information.

8. The method of claim 6, wherein the first object model is generated according to an identifier of the root element of the first wrapper.

9. The method of claim 6, further comprising:
establishing a data communication session between a second wrapper of a second browsing session and the proxy;
receiving a fourth message in the proxy from the first wrapper page, the fourth message comprising an identifier of the second browsing session, an identifier of the webpage element; and
transmitting the webpage element to the second browsing session via the second wrapper for rendering by the second browsing session via the second wrapper;
wherein the webpage element is selected via the overlay.

10. The method of claim 9, wherein the overlay elements comprise an element for selecting the at least one webpage element.

11. An apparatus for communicating data to a first browsing session, comprising:
a browser session communication system comprising:
a proxy for receiving a first information from a first browsing session, the first information comprising a request for a webpage having at least one webpage element and for transmitting a second information comprising a first wrapper distinct from the requested webpage;
means for establishing a first communications session between the first wrapper and the proxy; and
wherein the proxy further transmits a third information to the first browser via the first communications session, the third information comprising at least one element based on the requested webpage element for rendering by the first browsing session via the first wrapper.

12. The apparatus of claim 11, wherein:
the first wrapper comprises a script and a wrapper root element;
the first communications session is established at least in part by executing the script; and
the first browsing session renders the requested webpage element in the wrapper root element.

13. The apparatus of claim 11, wherein:
the first information and the second information are HTTP compliant; and
the first communications session is HTTP independent.

14. The apparatus of claim 11, wherein the first wrapper includes a list having at least one other browsing session communicating with the proxy via a second communications session.

15. The apparatus of claim 14, wherein the first wrapper includes a user interface for sending the webpage element to the at least one other browsing session.

16. The apparatus of claim 11, wherein the browser session communication system further comprises:
a virtual browser for retrieving an overlay having overlay elements, the overlay defining a presentation of data in the first browsing session;
a data object model compositor for generating first data object model information including the wrapper root element from the retrieved overlay; and
wherein the proxy transmits the first data object model information to first browsing session via the first communications session and the requested webpage element is rendered by the first browsing session via the first wrapper at least in part according to the first data object model information.

17. The apparatus of claim 16, wherein:
the virtual browser retrieves the requested webpage having the requested webpage element;
the data object model compositor generates second data object model information using the retrieved webpage element; and
the proxy transmits the generated second data object model information and the requested webpage element to the first browsing session via the first communications session;
wherein the requested webpage element are rendered by the first browser communications session via the first wrapper according to the first data object model information and the second data object model information.

18. The apparatus of claim 16, wherein the first object model is generated according to an identifier of the root element of the first wrapper.

19. The apparatus of claim 16, wherein:
the browser session communication system further establishes a data communication session between a second wrapper of a second browsing session and the proxy;
the proxy receives a fourth message from the first wrapper page, the fourth message comprising an identifier of the second browsing session, an identifier of the webpage element, and transmits the webpage element to the second browsing session via the second wrapper for rendering by the second browsing session via the second wrapper.

20. The apparatus of claim 19, wherein the overlay elements comprise an element for selecting the at least one webpage element.
